(19) United States
(12) Patent Application Publication
(10) Pub. No.: US 2022/0219045 A1
(43) Pub. Date: Jul. 14, 2022

(54) LINE DETECTING SYSTEM

(71) Applicants: Julien Duhautois, Des Moines, IA (US); Uzir Thapa, Cedar Rapids, IA (US)

(72) Inventors: Julien Duhautois, Des Moines, IA (US); Uzir Thapa, Cedar Rapids, IA (US)

(21) Appl. No.: 17/573,374

(22) Filed: Jan. 11, 2022

Related U.S. Application Data
(60) Provisional application No. 63/238,820, filed on Aug. 31, 2021.
(60) Provisional application No. 63/135,964, filed on Jan. 11, 2021.

(51) Int. Cl. A63B 24/00; G06V 40/20; A63B 71/06

(52) U.S. Cl. CPC A63B 24/0021; G06V 40/28; G06V 40/23; A63B 71/0622; A63B 2071/0655; A63B 2071/0625; A63B 2220/10; A63B 2024/0028; A63B 2024/0037; A63B 2225/54

(57) ABSTRACT

A system for detecting the position of a ball relative to a line includes a remote software application that is downloaded to at least one personal electronic device. The at least one personal electronic device has a camera positioned to have an unobstructed view of a court. The at least one personal electronic device is configured to collect information using computer vision as to the location of contact of a ball relative to a line. The collecting information is then transmitted to a remote location and processed to provide a signal as to whether the ball was out of a predefined acceptable region.

### CROSS REFERENCE TO RELATED APPLICATION

This application claims the benefit of U.S. Provisional Application Ser. No. 63/135,964 filed Jan. 11, 2021 and U.S. Provisional Application Ser. No. 63/238,820 filed Aug. 31, 2021, the contents of these applications are hereby incorporated by reference in their entirety.

### BACKGROUND OF THE INVENTION

The present invention is directed to a line and a ball detecting system and in particular a system for determining whether a sports ball is in or out of an area delimited by the lines.

Devices for detecting lines are well known in the art. While useful, these devices are complex, expensive to manufacture, and are limited in their use. More specifically, they require a device specifically designed for the purpose of detecting lines and balls. What is needed is a system that works on a device which users already own, or is easy for them to obtain and use, providing a solution in the form of a software application that works with a common device such as a smart phone, is easy to use, costs significantly less and has a broader scope of use.

The present invention is addressing the uncertainty about how an action in a sport is questioned relative to the rules of that sport. For example, in the sport of tennis when the ball bounces near the line, was it “in” or “out”, and how can it be known?

In many sports and at many levels, a referee is present to ensure the rules of the sport are enforced. In certain cases, the referee is assisted by technology such as video, machine learning, computer vision and artificial intelligence. As technology continues to evolve, the referee may be fully replaced by a system which can capture, analyze, and provide feedback when key actions in the sport are questioned. Some technologies provide real time feedback. Other technologies require a manual input on a device that triggers the automatic review processes to provide an answer. Accordingly, there exists a need in the art for a device that addresses these deficiencies.

An objective of the present invention is to provide a line and ball detecting system that works on a device already owned by a user.

Another objective of the present invention is to provide a line and ball detecting system that is easier to use, costs less, and has a broader scope of use.

These and other objectives will be apparent to those of ordinary skill in the art base upon the following written description, drawings and claims.

### SUMMARY OF THE INVENTION

A system for detecting the position of a ball relative to a line includes a remote software application that is downloaded to one or more personal electronic devices. The personal electronic devices have a camper that is positioned to have an unobstructed view of a court and is configured to collect information using computer vision as to the location of contact of a ball relative to a line. The collected information is then transmitted to a remote location and processed to provide a signal as to whether the ball was out of a predefined acceptable region.

The signal includes a flash, sound, and/or a vibration. Also, when multiple electronic devices are used they are synchronized or calibrated. One way of synchronizing is to display a QR code on one electronic device and scan the QR code on another electronic device.

In another example, one or more Artificial Intelligence algorithms are downloaded to one or more personal electronic devices. The Artificial Intelligence algorithms are configured to listen for an input that triggers the Artificial Intelligence to process a predetermined succession of video frames captured by the personal electronic devices. Based upon the processed succession of video frames the Artificial Intelligence algorithms provide a signal that indicates if the ball was outside of a predefined acceptable region. The input includes an intentional pose or movement or activation of a smart watch. As one example a player raises their arms straight above their head for three seconds. The indication of whether the ball was outside of the predefined acceptable are includes both visual and sound feedback.

### BRIEF DESCRIPTION OF THE DRAWINGS

FIG. 1 is a schematic view of a system for detecting the position of a ball relative to a line; and

FIG. 2 is a flow diagram of a system for detecting the position of a ball relative to a line.

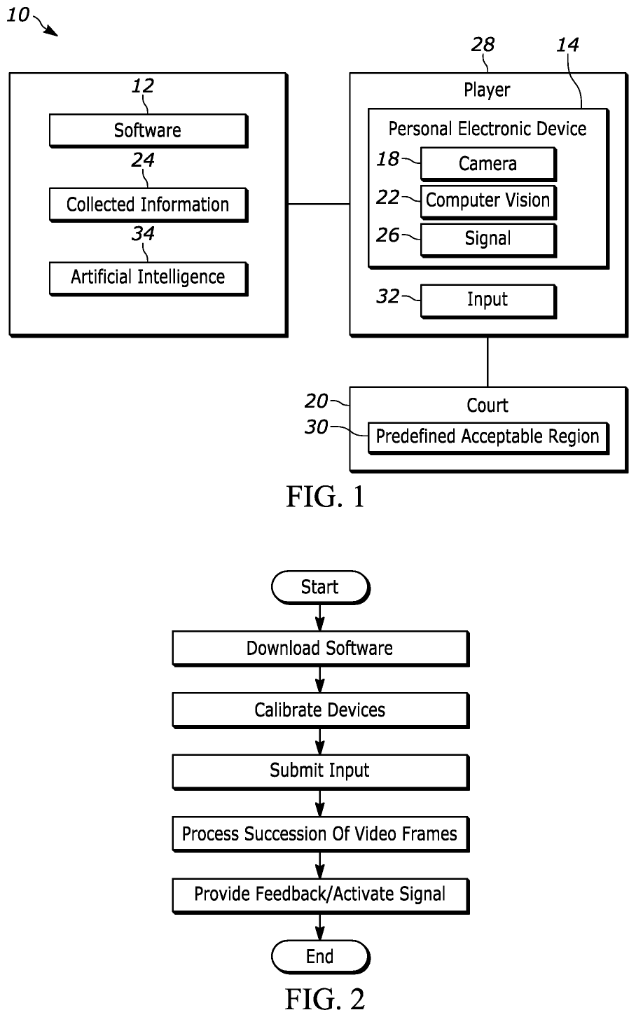

### DETAILED DESCRIPTION

A system defining the position of a ball relative to lines 10 includes a software application 12 for detecting lines that is adapted to be downloaded to a personal electronic device 14 such as a smartphone or the like. Once the application 12 is downloaded to the personal electronic device 14, the electronic device 14, which has a camera 16, is positioned so that the electronic device 14 is unobstructed and the camera 16 has a view of all or part of the court or playing field 20. The application 12 is activated and using computer vision 22 or external device, information 24 is collected by the electronic device 14 as to the location of contact of a ball relative to a line. The collected information 24 is transmitted to a remote location and processed in real time or asynchronous and a signal 26 is activated to indicate to a player 28 whether the ball was out of a predefined acceptable region 30. The signal 26 is of any type including but not limited to a visual such as a flash, sound, vibration on a connected smartwatch, or the like.

In another embodiment multiple electronic devices 14 are used to provide increased coverage of the field or court 20. The phones 14 are synchronized and will provide the signal 26 simultaneously. For example, once the application 12 is downloaded to the electronic device 14 a QR code is displayed on one electronic device 14 that is then scanned by another electronic device to synchronize and/or calibrate the phones 14. When phones 14 are used they may have battery and processing power limitations. To overcome this, the application code is native to Android and IOS which allows for the highest level of efficiency on a phone.

In another example, the system 10 requires an input 32, which causes Artificial Intelligence 34 to process a succession of video frames captured by one or multiple devices 14 such as the last ten seconds of video captured. The system then provides feedback related to that action being questioned.

The input 32 that triggers such review by the automated system does not require a manual input of any form. Instead, the Artificial Intelligence algorithm(s) 34 that listen for an intentional pose or movement 32 performed by a person 28, which is identified as a challenge and generates the analysis of the previous sport action for feedback.

For example, in tennis, when the ball bounces questionably near the line, a player 28 may raise their arms straight above their head for three seconds, and the system 10 interprets this pose 32 as questioning the location of the last ball bounce. The system 10 would process the previous succession of frames, and would provide visual and sound feedback 26 to indicate if the ball was in or out.

Therefore, a line and ball detection system 10 has been provided that provides that at the very least meets all the stated objectives, and improves upon the art.

From the above discussion and accompanying figures and claims it will be appreciated that the system 10 offers many advantages over the prior art. It will be appreciated further by those skilled in the art that other various modification could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A system for detecting the position of a ball relative to a line comprising:
a remote software application that is downloaded to at least one personal electronic device;
the at least one personal electronic device having a camera positioned to have an unobstructed view of a court;
the at least one personal electronic device configured to collect information using computer vision as to the location of contact of a ball relative to a line; and
wherein the collected information is transmitted to a remote location and processed to provide a signal as to whether the ball was out of a predefined acceptable region.

2. The system of claim 1 wherein the signal is selected from a group consisting of a flash, sound, and a vibration.

3. The system of claim 1 wherein the at least one personal electronic device includes multiple electronic devices that are synchronized with one another.

4. The system of claim 3 wherein the multiple electronic devices are synchronized by displaying a QR code on one electronic device and scanning the QR code on another electronic device.

5. A system for detecting the position of a ball relative to a line comprising:
one or more Artificial Intelligence algorithms downloaded to one or more personal electronic devices;
the one or more Artificial Intelligence algorithms configured to listen for an input that triggers the Artificial Intelligence algorithms to process a predetermined succession of video frames captured by the one or more personal electronic devices; and
wherein the Artificial Intelligence algorithms provide a signal based upon the processed predetermined succession of video frames to provide an indication if a ball was outside of a predefined acceptable region.

6. The system of claim 5 wherein the input includes an intentional pose or movement performed by a player.

7. The system of claim 6 wherein the intentional pose or movement occurs when a player raises their arms straight above their head for three seconds.

8. The system of claim 5 wherein the indication of whether the ball was outside of the predefined acceptable regions includes both visual and sound feedback.
